(19) United States
(12) Patent Application Publication
(10) Pub. No.: US 2010/0057508 A1
(43) Pub. Date: Mar. 4, 2010

(54) STRUCTURED IMPLEMENTATION OF BUSINESS FUNCTIONALITY CHANGES

(75) Inventors: Eric S. Merrifield, JR., Seattle, WA (US); Chad K. Corneil, Snoqualmie, WA (US); Charles A. Pitcher, Clyde Hill, WA (US)

Correspondence Address: WORKMAN NYDEGGER/MICROSOFT, 1000 EAGLE GATE TOWER, 60 EAST SOUTH TEMPLE, SALT LAKE CITY, UT, 84111, US

(73) Assignee: Microsoft Corporation, Redmond, WA (US)

(21) Appl. No.: 12/202,920

(22) Filed: Sep. 2, 2008

(51) Int. Cl. G06Q 10/00

(52) U.S. Cl. 705/7

(57) ABSTRACT

The present invention extends to methods, systems, and computer program products for structured implementation of business functionality changes. A pre-defined resource vocabulary is utilized to assist in determining if a business capability change is worthwhile. The pre-defined resource vocabulary provides a mechanism for a plurality of different organizations to consider business capability changes in a uniform, repeatable, and consistent manner.

### CROSS-REFERENCE TO RELATED APPLICATIONS

Not Applicable.

### BACKGROUND

### Background and Relevant Art

Computer systems and related technology affect many aspects of society. Indeed, the computer system's ability to process information has transformed the way we live and work. Computer systems now commonly perform a host of tasks (e.g., word processing, scheduling, accounting, etc.) that prior to the advent of the computer system were performed manually. More recently, computer systems have been coupled to one another and to other electronic devices to form both wired and wireless computer networks over which the computer systems and other electronic devices can transfer electronic data. Accordingly, the performance of many business related processes are distributed across a number of different computer systems and/or a number of different computing components.

The ability of an organization to change its processes is important to staying competitive in a given field. The need for change is often identified as a result of some detected internal or external event, such as, example, under performing or over performing business units, new competing products, regulatory changes, etc. In many organizations, events are not explicitly defined. On the other hand, there is a subjective “I will know it when I see it” approach.

Prior to maturity of the Internet, a decision maker would look essentially solely inside the organization for available resources (e.g., at available people, processes, technology, and governance) with an eye on time and financial constraints, when determining how to respond to an event. The inside only view offered a decision-maker a small list of actionable alternatives, and the best alternative was often obvious and because there were so few options, the risk associated with choosing the wrong alternative was low. Additionally, the pace of many businesses was slower prior to the developed Internet. Thus, a decision-maker could fail in the initial response to the event, and have time to try again. Accordingly, a wrong alternative could often be corrected prior to realizing negative impacts of the wrong alternative.

However, as the Internet (and interconnectivity between organizations in general) matures, the pace of business and available alternatives to responding to an event continue to increase. Through outsourcing, on-demand services, open source, etc., decisions makers have significantly more alternatives to choose from when responding to an event. Decision-makers have alternatives that are starting to seem infinite in terms of people, processes, time, location, cost, etc. As a result, at least in part due to the sheer number of alternatives, it is significantly more difficult to identify appropriate alternatives. There is also increased risk associated with choosing an inappropriate alternative to an event. For example, due to the increased pace of change, there is often little if any time for an organization to change alternatives without further negative impacts to the organization (e.g., getting left behind by the competition).

The pace of business can make it difficult for decision makers to identify when capability changes are appropriate based on changed conditions in their business environment. For example, there is often no way to determine the need scope and/or resulting impact of a proposed change in capabilities prior to making the change. For example, is a minor managerial change needed to increase performance or is a truly innovative change need to increase performance. Further, can implementation of a change be coordinated with a department or divisions or is enterprise or even industry wide coordination required? Accordingly, based on such uncertainty it can be difficult to determine when an organizations capabilities can be removed, added, or changed to truly increase performance.

Further even when the scope and impact of changes are considered when determine if a changes are worthwhile, there is typically no common definition of what “change” is or what it means to be innovative. Thus, discussions of capability changes within and/or across organizations are not always based on a common vocabulary. Without a common vocabulary to describe capability changes and their impact, information exchanged with respect to capability changes is often inaccurate and/or incomplete information. As such, the timing of implementing capability changes and/or benefits of investment capability changes can not be determined or may be incorrect.

Without a common definition of change and metrics for determining when capability changes may or may not be of value, it is also difficult to formulate computer based tools and methods to assist in determining when capability changes might be value. As result, organizations can have further difficulties appropriately incorporating capability changes into existing business models. For example, it can be difficult for an organization to differentiate particular business components that would benefit from a change in capability.

Without computer based tools and methods, the problem grows increasing complex as the size of an organization increases. For example, a large multi-national corporation may have virtually no way to determine that when a change to one process within one of hundreds or thousands of business units is financially worthwhile, when such considerations are not integrated into their business models. Thus, an organization's investment in change is ultimately often an unstructured process, the benefits of which are difficult to measure.

### BRIEF SUMMARY

The present invention extends to methods, systems, and computer program products for structured implementation of business functionality changes. Embodiments of the invention include structured implementation of a change to the business capability of some aspect of an organization, such as, for example, to improve the performance of the organization (e.g., sell more widgets, produce widgets more efficiently, reduce overhead, etc.). A set of a set of conditions relevant to the ability of one or more of the organization's business capabilities is identified.

Determining relevancy includes referring to a pre-defined common vocabulary for business change. The pre-defined common vocabulary defines a range of business change. The pre-defined common vocabulary provides a mechanism for a plurality of different organizations to consider business change in a uniform manner and provides a mechanism to produce consistent repeatable results for considered business changes.

Determining relevancy also includes referring to a collection of business capabilities representing the performance of the organization. Determining relevancy also includes determining that the set of conditions is relevant to the one or more business capabilities, from among a collection of business capabilities, based on the pre-defined common vocabulary for business change.

Any significant business capabilities, from among the relevant business capabilities, are identified. Significant business capabilities are business capabilities that expressly and in an asserted fashion impact the performance of the organization in view of the set of conditions. It is determined that a change to a portion of the significant business capabilities would improve the performance of the organization in a cost efficient manner, based on the pre-defined common vocabulary for business change. The determination includes identifying the significance of the change to apply to the portion of significant business capabilities. The determination also includes identifying the level of coordination within the organization for applying the change to the portion of significant business capabilities. The change is applied to the portion of the significant business capabilities in response to the determination so as to improve the performance of the organization in view of the set of conditions.

This summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates an example computer architecture that facilitates structured implementation of organizational capability changes.

FIG. 2 illustrates a flow chart of an example method for implementing a structured capability change to some aspect of an organization.

FIGS. 3A and 3B illustrate a visual representation of a collection of business capabilities at varied levels of detail.

FIG. 3C illustrates an example of a modeled business capability.

FIG. 3D illustrates a first view of an example of a network of modeled business capabilities.

FIG. 3E illustrates a second view of the example of a network of modeled business capabilities.

FIG. 4 illustrates a change spectrum.

FIG. 5 illustrates an adaptability spectrum.

### DETAILED DESCRIPTION

The present invention extends to methods, systems, and computer program products for structured implementation of business functionality changes. Embodiments of the invention include structured implementation of a change to the business capability of some aspect of an organization, such as, for example, to improve the performance of the organization (e.g., sell more widgets, produce widgets more efficiently, reduce overhead, etc.). A set of a set of conditions relevant to the ability of one or more of the organization's business capabilities is identified.

Determining relevancy includes referring to a pre-defined common vocabulary for business change. The pre-defined common vocabulary defines a range of business change. The pre-defined common vocabulary provides a mechanism for a plurality of different organizations to consider business change in a uniform manner and provides a mechanism to produce consistent repeatable results for considered business changes.

Determining relevancy also includes referring to a collection of business capabilities representing the performance of the organization. Determining relevancy also includes determining that the set of conditions is relevant to the one or more business capabilities, from among a collection of business capabilities, based on the pre-defined common vocabulary for business change.

Any significant business capabilities, from among the relevant business capabilities, are identified. Significant business capabilities are business capabilities that expressly and in an asserted fashion impact the performance of the organization in view of the set of conditions. It is determined that a change to a portion of the significant business capabilities would improve the performance of the organization in a cost efficient manner, based on the pre-defined common vocabulary for business change. The determination includes identifying the significance of the change to apply to the portion of significant business capabilities. The determination also includes identifying the level of coordination within the organization for applying the change to the portion of significant business capabilities. The change is applied to the portion of the significant business capabilities in response to the determination so as to improve the performance of the organization in view of the set of conditions.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical storage media and transmission media.

Physical storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, it should be understood, that upon reaching various computer system components, program code means in the form of computer-executable instructions or data structures can be transferred automatically from transmission media to physical storage media (or vice versa). For example, computer-executable instructions or data structures received over a network or data link can be buffered in RAM within a network interface module (e.g., a “NIC”), and then eventually transferred to computer system RAM and/or to less volatile physical storage media at a computer system. Thus, it should be understood that physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

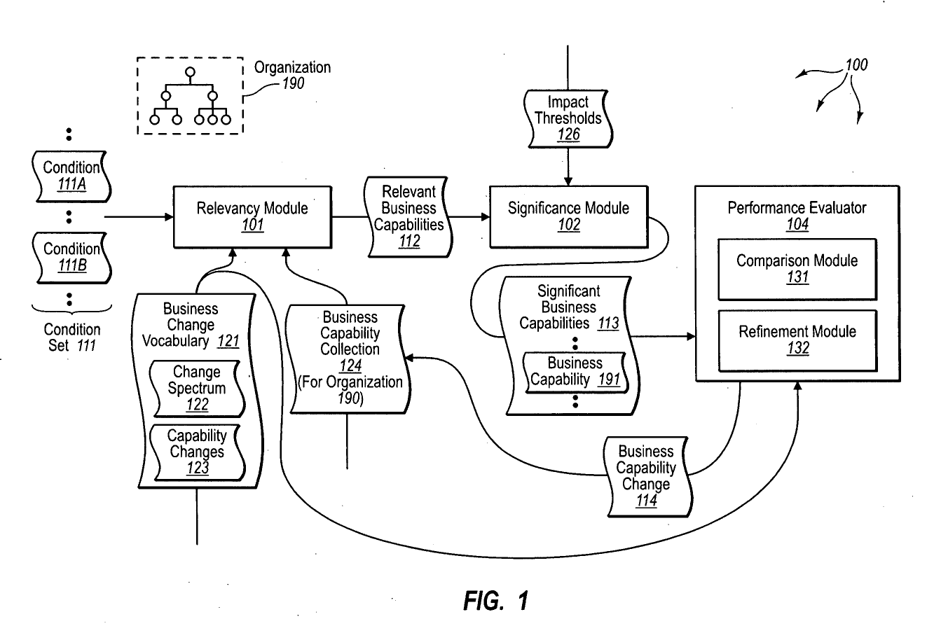

FIG. 1 illustrates an example computer architecture 100 that facilitates structured implementation of organizational capability changes. Referring to FIG. 1, computer architecture 100 includes relevance module 101, significance module 102, and performance evaluator 104. Each of the depicted components can be connected to one another over (or be part of) a network, such as, for example, a Local Area Network (“LAN”), a Wide Area Network (“WAN”), and even the Internet. Accordingly, each of the depicted components as well as any other connected components, can create message related data and exchange message related data (e.g., Internet Protocol (“IP”) datagrams and other higher layer protocols that utilize IP datagrams, such as, Transmission Control Protocol (“TCP”), Hypertext Transfer Protocol (“HTTP”), Simple Mail Transfer Protocol (“SMTP”), etc.) over the network.

Generally, relevancy module 101 is configured to receive a set of conditions and a collection of business capabilities for an organization. An organization can be virtually any type of business related entity, such as, for example, a corporation (profit or non-profit), a partnership, a limited partnership (“LP”), a limited liability partnership (“LLP”), a limited liability corporation (“LLC”), a sole proprietorship, etc. Based on a pre-defined business change vocabulary, relevancy module 101 can determine and output any business capabilities that are relevant to the set of conditions.

A set of conditions can represent an existing environment in which the organization is operating. For example, the environment the business environment of an organization that causes the organization to consider a change to one or more business capabilities. For example, a set of conditions can represent an existing business environment, a proposed alteration to an existing environment, etc. A set of conditions can map to an external exception or variance resulting from the activities of customers, competitors, partners, suppliers, regulatory agencies, financial services organizations, etc. A set of conditions can also represent an internal exception or variance relative to existing business expectations, metrics, or plans. An internal exception or variance can result from creation of products and services, demand generation, fulfillment of demand, planning and managing, etc, within an organization.

A set of conditions can also represent normal business operations. For example, an organization can proactively (as opposed to reactively) manage its change and make decisions about what change is appropriate prior to the occurrence of any exceptions or variances.

Generally, a pre-defined common vocabulary provides a mechanism for a plurality of different organizations to consider changes in business capabilities in a uniform manner. A pre-defined common vocabulary also provides a mechanism to produce consistent repeatable results for considered changes in business capabilities.

A pre-defined business change vocabulary can include a spectrum of change along a plurality of axes. One axis can represent the significance of a change within a range of significance. For example, the significance of a change can range from a managerial adjustment to keep a capability within specific guardrails (i.e., tolerance boundaries relative to pre-defined metrics for over/under performance) for defined performance goals, to a more significant adjustment to change a capability beyond define guardrails (e.g., project with an existing and a targeted image), and to change resulting in a true transformation of work/output (i.e., an innovation). Another axis can represent a level of organizational coordination for implementing the change with a range of levels of organization. For example, organization levels can range from individual to department/division to business unit to enterprise to industry.

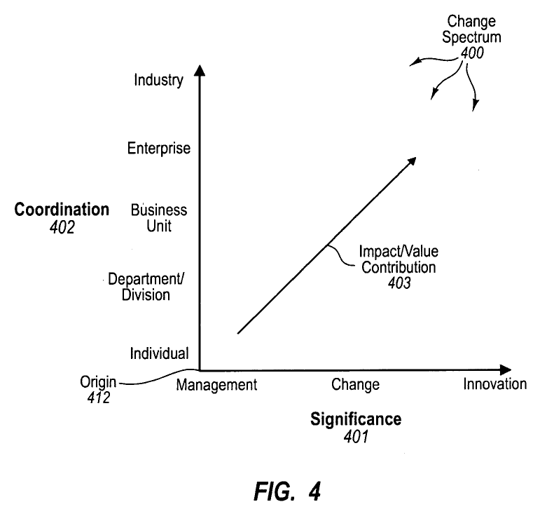

In some embodiments, axes can be used to represent a grid. The grid can be used to estimate the cost associated with a change. The cost can then be compared against models implementing the change to determine if the change is worthwhile, for example, in view of time cost and constraints, disruption impact, risk, financial impact (e.g., results in increase revenue, savings, cuts costs, etc.). For example, referring briefly to FIG. 4, FIG. 4 depicts change spectrum 400. As depicted, change spectrum 400 includes significance axis 401 and coordination axis 402. Along significance axis 401 the significance of change increases from management to change to innovation. Likewise, along coordination axis 402 the level of coordination for implementing a change increases from individual to department/division to business unit to enterprise to industry.

Impact/value contribution 403 generally represents an impact and/or value to an organization of performing a change of a specified significance and a specified level of coordination. Thus, as the significance of a change increases so does the impact/value. For example, there is likely more impact/value to implementing an innovation for a business capability than to adjust management to better meet existing goals for a business capability. Likewise, as the organization coordination for change increases so does the impact/value. For example, there is likely to cost more impact/value to change an enterprise wide business capability than to change a department business capability. Thus, as change moves away from origin 412 (either vertically or horizontally) the impact/value associated with change increases. Generally, impact/value represents impact and/or value on organizational resources, such as, for example, one or more of financial, material, technical, personnel resources, time, disruption impact, and risk.

Further, impact/value contribution 403 generally indicates that impact/value increases as significance and level of coordination move away from origin 412. However, there is not necessarily a linear relationship between significance and level of coordination. Depending on the business capabilities for an organization and proposed changes to the business capabilities, the relationship between significance and level of coordination can result in a logarithmic impact/value curve, an exponential impact/value curve, or a curve based on virtually any other function.

When the cost for a change is under impact/value contribution 403 (or any other impact/value curve) then there is at least some objective evidence that the change is justified and/or worthwhile to an organization. For example, below an impact/value cure, an organization may make more from changed business capabilities than it costs to implement the change. On the other hand, when the cost for a change is over impact/value contribution 403 (or any other impact/value curve) then there is at least some objective evidence that the change is not justified and/or worthwhile to an organization. For example, above an impact/value cure, an organization may not recoup from changed business capabilities what it costs to implement the change.

A pre-defined business change vocabulary can also define business capability changes. Business capability changes are activities that an organization can implement to change the functionality of current business capabilities. Business capability changes can include how to alter an existing business capability to change the functionality of the existing business capability. For example, a business capability change can indicate how transform a paper payroll system into a computer based payroll system.

Embodiments of the invention can include considering changes to and changing a variety of different types of business capabilities. Business capability changes can be considered and implemented for economic driver/core capabilities that differentiate (e.g., brand) and directly impact business performance metrics. For example, if an organization produces widgets, business capabilities related to the sale of widgets, acquiring sub-components to make widgets, production efficiency of widgets, widgets produced to the specific preferences or requirements of some or all customers, etc., can be considered economic driver/core capabilities.

Business capability changes can also be considered and implemented for enabling or infrastructure capabilities. Enabling or infrastructure capabilities are part of a business and have to be performed. However, enabling or infrastructure capabilities do not necessary correlate with more important business performance metrics. For example, referring back to the example of producing widgets, payroll is likely a required capability. However, payroll does impact the production of widgets to the extent of the other previously listed capabilities.

Business capability changes can also be considered and implemented for management capabilities, including executive managers and managers at other levels of an organization.

In some embodiments, the business capabilities for an organization are included together in a collection of business capabilities. A collection of business capabilities can be represented as a (e.g., structured or schematized) business capability model. An organization can formulate business capability attributes representing current performance of their collection of business capabilities. A modeling application (not shown) can receive the business capability attributes (e.g., from a business capability business layer) and model the business capability attributes into a business capability model. A business capability model can be represented in a variety of different ways depicting various levels of detail (e.g., up to the level of detail of the business capability attributes). A business capability model can be configured visually for output at a user-interface and/or can be retained as data for further processing.

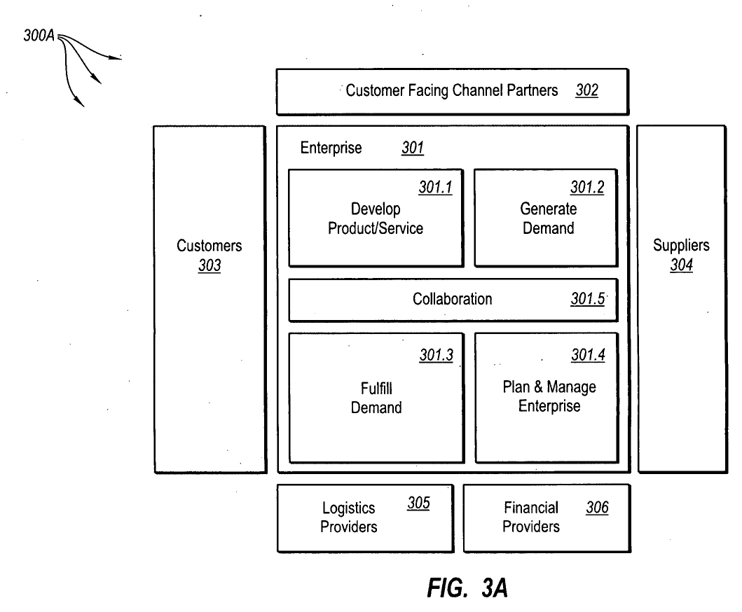

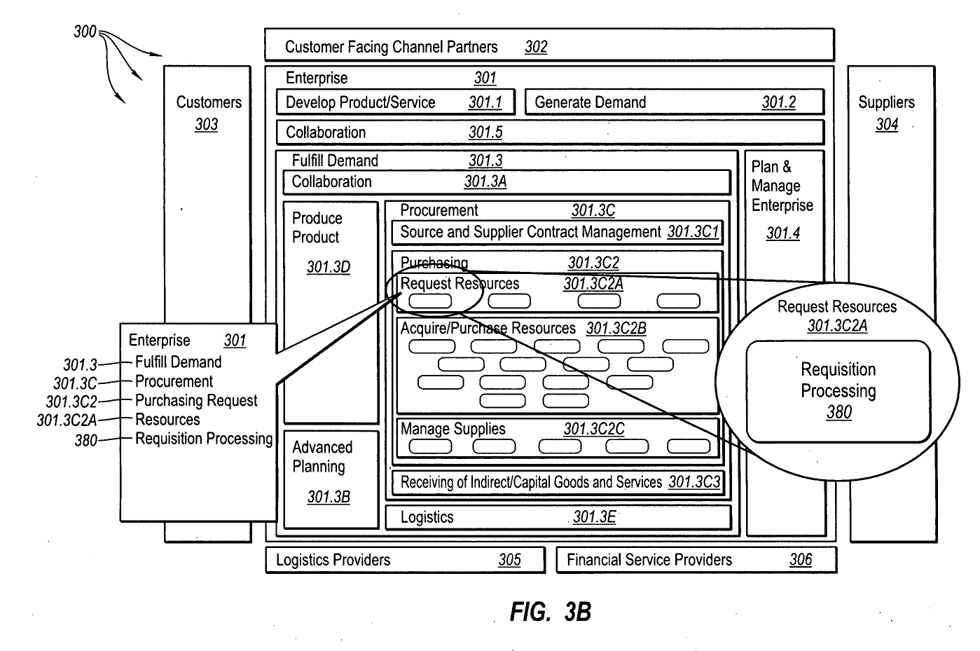

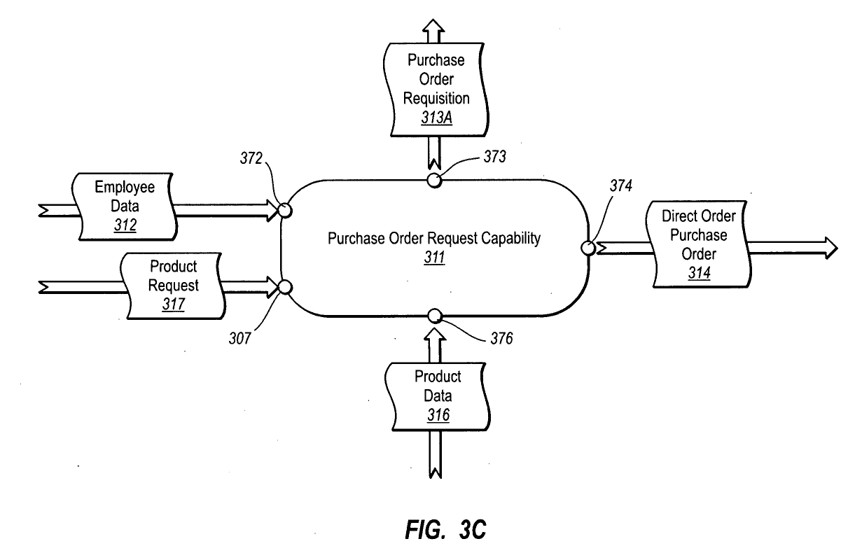

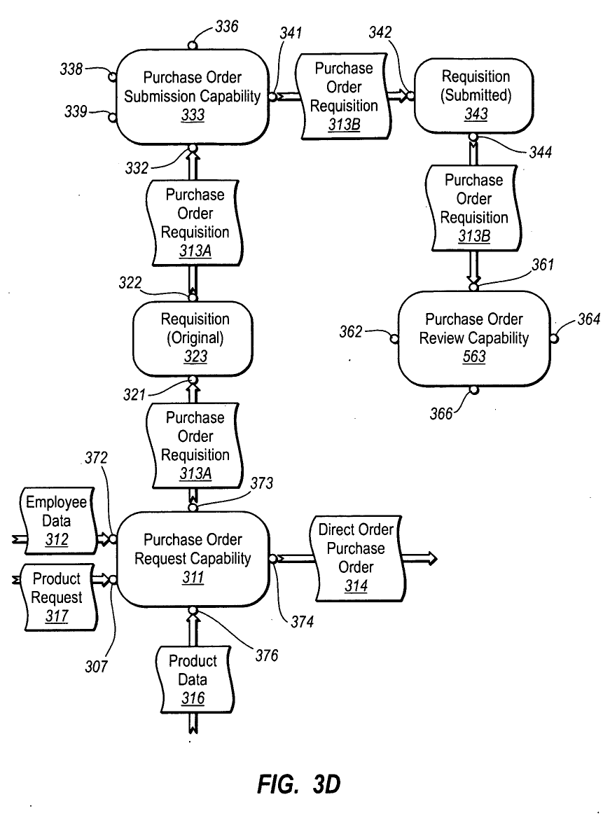

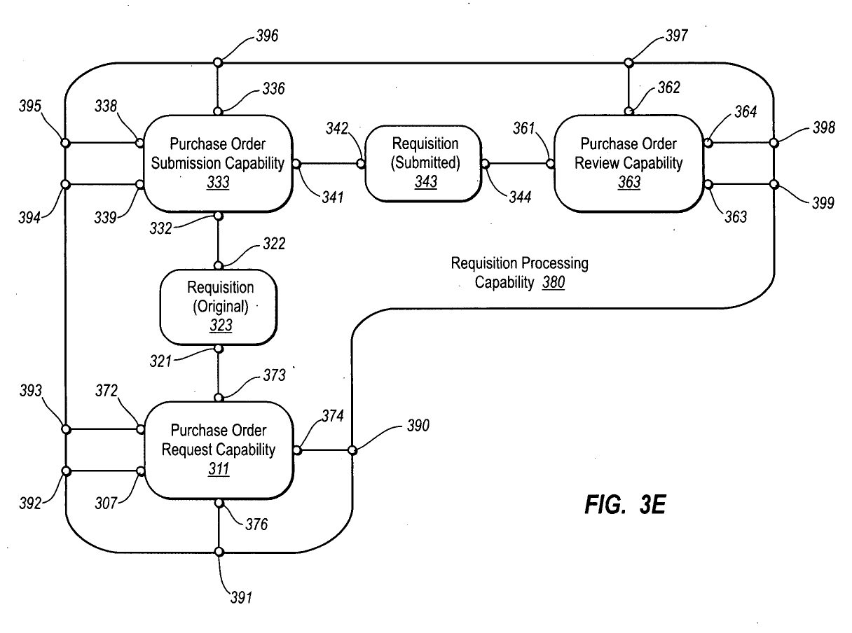

Levels of detail can be used to represent (potentially interconnected) sub-capabilities that contribute to the performance other capabilities. FIGS. 3A through 3E depicted collections of business capabilities having various levels of detail and interconnection. Referring now to FIG. 3A, FIG. 3A depicts an example visual representation 300 (e.g., a model) of a collection of business capabilities for an organization. As depicted, the visually rendered business capabilities in visual representation 300 are rendered with varied levels of detail. For example, customer facing channel partners 302, customers 303, suppliers 304, logistic providers 305, and financial providers 306 are rendered with less detail. On the other hand, enterprise 301 is rendered with more detail, depicting other business capabilities that contribute to the performance of enterprise 301. For example, develop product service 301.1, generate demand 301.2, fulfill demand 301.3, plan and manage enterprise 301.4, and collaboration 301.5 are expressly rendered within enterprise 301. Thus, visual representation 3000 represents that develop product service 301.1, generate demand 301.2, fulfill demand 301.3, plan and manage enterprise 301.4, and collaboration 301.5 contribute to the performance of enterprise 301.

Turning now to FIG. 3B, FIG. 3B depicts visual representation 300 with further levels of detail. FIG. 3B is representative of the way business capabilities can be broken down/decomposed into other capabilities. For example, fulfill demand 301.3 is increased by a number of levels of detail. Fulfill demand 301.3 includes collaboration 301.3A, advanced planning 301.3B, procurement 301.3C, produce product 301.3D, and logistics 301.3E. Thus, collaboration 301.3A, advanced planning 301.3B, procurement 601.3C, produce product 301.3D, and logistics 301.3E contribute to the performance of fulfill demand 301.3 (and as a result also contribute to the performance of enterprise 301).

Procurement 301.3C is further detailed to include source and supplier contract management 301.3C1, purchasing 301.3C2, and receiving of indirect/capital goods and services 301.3C3. Thus, contract management 301.3C1, purchasing 301.3C2, and receiving of indirect/capital goods and services 301.3C3 contribute to the performance of procurement 301.3C (and as a result also contribute to the performance of fulfill demand 301.3 and performance of enterprise 301).

Purchasing 301.3C2 is further detailed to include request resources 301.3C2A, acquire/purchase resources 301.3C2B, and manage supplies 301.3C2C. Thus, request resources 301.3C2A, acquire/purchase resources 301.3C2B, and manage supplies 301.3C2C contribute to the performance of purchasing 301.3C2 (and as a result also contribute to the performance of procurement 301.3C, fulfill demand 301.3, and performance of enterprise 301). Requisition processing 380 is a further sub-capability of request resources request resources 301.3C2A.

Business capability models can also represent data that flows into and data that flows out of the modeled business capabilities. For example, FIG. 3C illustrates an example of a modeled business capability. FIG. 3C, includes purchase order request capability 311 (e.g., modeled based on structured capability data format). Purchase order request capability 311 includes ports 372, 376, and 307 (e.g., modeled based on a structured port data format) that receive employee data 312, product data 316, and product request 317 respectively (e.g., from other business capabilities). Purchase order request capability 311 can use employee data 312, product data 316 and product request 317 to formulate a purchase order request.

Purchase order request capability 311 includes ports 373 and 374 (e.g., modeled based on the structured port data format) that can send purchase order requisition 313A and direct order purchase order 314 respectively (e.g., to other business capabilities). Purchase order request capability 501 can include logic that determines, based on one or more of receive employee data 312, product data 316 and produce request 317, whether purchase order requisition 513A and/or direct order purchase order 314 is to be sent.

Thus, embodiments of the present invention can also utilize models of a network of business capabilities. A first business capability is modeled based upon formatted business capability attributes. A second business capability is modeled based upon the formatted business capability attributes. A connection between the first business capability and the second capability is modeled based upon the formatted business capability attributes.

FIG. 3D illustrates a first view of an example of a network of modeled business capabilities including purchase order request capability 311. As depicted, purchase order request capability 311 (a capability) sends purchase order request 313A out of port 373 to requisition 323 (a connector).

Requisition 323 receives purchase order requisition 313A at port 312. Requisition 323 sends purchase order requisition 313A out of port 322 to purchase order submission capability 333. Thus, requisition 323 transfers purchase order requisition 313A from purchase order request capability 311 to purchase order submission capability 333. Accordingly, a connector can be viewed as a business capability wherein the capability of the connector is to transfer data between other capabilities.

Purchase order submission capability 333 receives purchase order requisition 313A at port 332. Purchase order submission capability 333 includes other ports, including ports 336, 338, 339, and 341. Each of the ports 336, 338, 339, and 341 can be used to send data to and/or receive data from other capabilities or connectors. More specifically, purchase order submission capability 332 sends purchase order 313B out of port 341 to requisition 343 (a connector). Although similar to purchase order requisition 313A, purchase order requisition 313B can differ from purchase order 313A as a result of processing at purchase order submission capability 332.

Requisition 343 receives purchase order requisition 313B at port 342. Requisition 343 sends purchase order requisition 313B out of port 344 to purchase order review capability 363. Purchase order review capability 563 receives purchase order requisition 313B at port 361. Purchase order review capability 363 includes other ports, including ports 362, 364, and 366. Each of the ports 362, 364, and 366 can be used to send data to and/or receive data from other capabilities or connectors.

Although one-way ports and connectors have been depicted in FIG. 3D, it should be understood that embodiments of the present invention can include two-way ports and/or two-way connectors. For example, it may be that, from time to time, requisition 323 also transfers data from purchase order submission capability 333 (coming out of port 332 and into port 322) to purchase order request capability 311 (coming out of port 321 and into port 373). Similarly, it may be that, from time to time, requisition 343 also transfers data from purchase order review capability 363 (coming out of port 361 and into port 344) to purchase order submission capability 333 (coming out of port 342 and into port 341).

A network of business capabilities can also be represented in a manner that abstracts the data exchanged between various business capabilities and connectors in the business capability network. Further, in some embodiments and as previously described, a network of more granular business capabilities (or those at higher levels of detail) can be used to model a more coarse business capability (or those at lower levels of detail). FIG. 3E illustrates a second view of the example of a network of modeled business capabilities in FIG. 3D representing requisition processing capability 380 (from FIG. 3B).

The network of business capabilities in FIG. 3E abstracts out the data that is exchanged between the business capabilities and connections in FIG. 3D. FIG. 3E further depicts that the more granular business capabilities and connections in FIG. 3D can be used to model a more coarse requisition processing capability 380. Ports 390-399 represent that requisition processing capability 380 can exchange data with other business capabilities and connectors, for example, included in request resources 301.3C2A (of FIG. 3B) or in part of some other general procurement network of business capabilities.

Although particular models have been described with respect to FIGS. 3A-3E, embodiments of the invention are not so limited. Embodiments of the invention can be practiced with virtually any type of model that represents business capabilities and/or business processes.

Returning to FIG. 1, significance module 102 is configured to receive relevant business capabilities. Based on impact thresholds, significance module 102 can identify and output significant business capabilities (from among the relevant business capabilities) that impact performance of the organization. An impact threshold indicates a requisite impact on performance that a business capability is to have before a change to the business capability is considered. An impact threshold can be a number, percentage, or some other indicator. Accordingly, a significant business capability (e.g., an economic driver or core business capability) is a business capability that satisfies an impact threshold (and thus likely has an increased impact on the performance of an organization) relative to impact/value contribution.

Significance module 102 can compare the performance impact of each relevant business capability to appropriate impact thresholds. Business capabilities that satisfy appropriate impact thresholds can be forwarded on to performance evaluator 104. On the other hand, business capabilities that do not satisfy appropriate impact thresholds are dropped. Thus, impact thresholds can be used to filter out capabilities that, while relevant, have a reduced impact on an organizations performance.

Significance module 102 can determine the performance impact of a business capability in a variety of different ways. For example, significance module 102 can derive a capability's impact on performance from the number of interconnections to other business capabilities. That is, well connected capabilities can have a greater impact on performance than lesser connected capabilities. As such, considering changes to well connected capabilities can potentially be viewed as more worthwhile.

Significance module 102 can also consider the types of data (e.g., product sales data, financial agreement data, human resources data, etc) that pass through a business capability when deriving a capability's impact on performance. When data related to economic drivers and core functions of an organization pass through a business capability, this can indicate that the business capability has an increased impact on performance. For example, when an organization produces widgets, a business capability that inputs and/or outputs demand fulfillment data for widgets can have an increased impact on the performance of the organization. On the other hand, for the same organization, a business capability that inputs and/or outputs human resources data likely has less of an impact on the performance of the organization.

Alternately, a collection of business capabilities can expressly indicate (e.g., economic driver or core) capabilities that have a relatively significant impact on organization performance.

Performance evaluator 104 is configured to receive significant business capabilities. Based on the pre-defined business change vocabulary, performance evaluator 104 can determine if a change to any significant business capabilities would improve the performance of the organization with at least a basic understanding of organizational impact (disruption), cost, and risk. Any change that would result in improved performance can be incorporated back into the collection of business capabilities. Accordingly, embodiments of the invention can determine that a proposed change is or is not worthwhile based on cost associated with a proposed change (e.g., represented in change spectrum 400) compared to any organization benefit associated with implementing the change.

As depicted performance evaluator 104 includes comparison module 131 and refinement module 132. Generally, comparison module 131 is configured to compare received significant business capabilities to potential business capability changes to the received significant business capabilities. For example, a shipping capability can be compared to a proposed modified version of the shipping capability. Comparison module 131 can compare based on measurable business objectives, such as, for example, cost, production efficiency, etc. Results of a comparison can reveal if changing a business capability would improve performance for the organization. Potential business capability changes can be implemented from defined capability changes in a pre-defined business change vocabulary.

If a potential business capability change results in improved performance, the change can be incorporated back into the collection of business capabilities. Refinement module 132 is configured to refine a collection of business capabilities to implement a business capability change for one or more business capabilities. Refinement can include altering how a business capability does its work. Accordingly, refinement module 132 can formulate a business capability change that is integrated back into a collection of business capabilities.

An business capability change can address a set of conditions relative to a change in business environment, and can include addressing an exception or variance relative to existing business expectations, metrics, or plans indicated in an internal or external change trigger event. A business capability change can also be used to proactively adjust prior to the occurrence of any exceptions or variances.

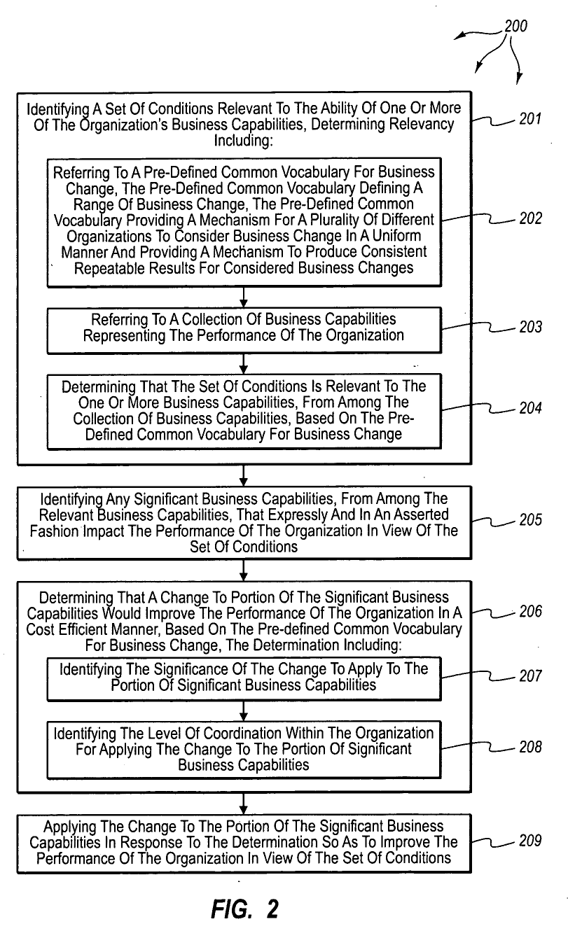

FIG. 2 illustrates a flow chart of an example method 200 for implementing a structured change to the business functionality of some aspect of an organization. Method 200 will be described with respect to the components and data in computer architecture 100.

Method 200 includes an act of identifying a set of conditions relevant to the ability of one or more of the organization's business capabilities (act 201). For example, condition set 111 can include one or more conditions, including conditions 111A and 111B, indicating a portion of an operating environment for organization 190. Relevancy module 101 can determine that condition set 111 is relevant to the functionality of relevant business capabilities 112.

Determining relevancy includes an act of referring to a pre-defined common vocabulary for business change, the pre-defined common vocabulary defining a range of business change, the pre-defined common vocabulary providing a mechanism for a plurality of different organizations to consider business change in a uniform manner and providing a mechanism to produce consistent repeatable results for considered business changes (act 202). For example, relevancy module 101 can refer to business change vocabulary 121, including change spectrum 122 and capability changes 123. Change spectrum 122 can define a range of capability changes, such as, for example, as depicted in change spectrum 400.

Determining relevancy also includes an act referring to a collection of business capabilities representing the performance of the organization (act 203). For example, relevancy module 101 can refer to business capability collection 124. Business capability collection 124 can be a model representing the performance of organization 190.

Determining relevancy can also include an act of determining that the set of conditions is relevant to the one or more business capabilities, from among the collection of business capabilities, based on the pre-defined common vocabulary for business change (act 204). For example, relevancy module 101 can determine that condition set 111 is relevant to relevant business capabilities 112 (a subset of business capability collection 124) based on business change vocabulary 121.

Method 200 includes an act of identifying any significant business capabilities, from among the relevant business capabilities, that expressly and in an asserted fashion impact the performance of the organization in view of the set of conditions (act 205). For example, significance module 102 utilizes impact thresholds 126 to identify significant business capabilities 113 from relevant business capabilities 112. Relevant business capabilities 112 that satisfy impact thresholds 126 are included in significant business capabilities 113. Thus, in some embodiments, a capability change is considered (potentially only) for capabilities that are relevant to responding to a set of conditions and that significantly impact an organizations performance. Accordingly, resources are not expended to evaluate capabilities that, while relevant, do not significantly impact an organizations response to a set of conditions.

Method 200 includes an act of determining that a change to portion of the significant business capabilities would improve the performance of the organization in a cost efficient manner, based on the pre-defined common vocabulary for business change (act 206). For example, performance evaluator 104 can determine that a business capability change 114 to business capability 191 would improve organization 190's performance in a cost efficient manner based on business change vocabulary 121. Performance evaluator 104 can refer to capability changes 123 to generate potential capability changes (including business capability change 114) to significant business capabilities 113.

Determining that a change to a portion of the significant business capabilities would improve the performance of the organization can include an act of identifying the significance of the change to apply to the portion of significant business capabilities (act 207). For example, performance evaluator 104 can identify the significance of business capability change 114 (e.g., on a significance axis of change spectrum 122) to business capability 191. Determining that a change to portion of the significant business capabilities would improve the performance of the organization can also include an act of identifying the level of coordination within the organization for applying the change to the portion of significant business capabilities (act 208). For example, performance evaluator 104 can identify the level of coordination within organization 190 to implement business capability change 114 (e.g., on a coordination axis within change spectrum 122) to business capability 191.

Performance evaluator 104 can associate a cost with business capability change 114 based on the significance and level of coordination for implementation in change spectrum 122. Refinement module 132 can simulate implementation of business capability change 114 to business capability 191 into business capability collection 124. Performance evaluator 104 can then identify any improved performance in business capability collection 124 resulting from simulated implementation of business capability change 114. Comparison module 131 can evaluate any identified improved performance against the associated cost of business capability change 114 to determine if business capability change 114 is worthwhile (e.g., increases revenue, cuts costs, etc.) for actual implementation.

If comparison module 131 determines that business capability change 114 is not worthwhile, organization 190 can choose not to implement business capability change 114. On the other hand, if comparison module 131 determines that business capability change 114 is worthwhile, organization 190 can choose to implement business capability change 114 resulting in a permanent change to business capability 191. Accordingly, method 200 can include an act of applying the change to the portion of the significant business capabilities in response to the determination so as to improve the performance of the organization in view of the set of conditions (act 209). For example, refinement module 132 can apply business capability change 114 to business capability 191 so as to improve the performance of business capability collection 124.

In some embodiments, a business capability change is a change in a business capability's ability to adapt. For example, a pre-defined business change vocabulary can also include a spectrum of adaptability ranging from increased ability to adapt to decreased ability to adapt. Within this specification and the following claims, “agility” is defined as ready to adapt to changing business requirements within specific time constraints relevant to the specific business capability. Within this specification and the following claims, “flexibility” is defined as ready to adapt to changing business requirements with no specifics relative to time or timeliness. Within this specification and the following claims, “consistent” and “durable” are defined as not ready or able to adapt to changing business requirements.

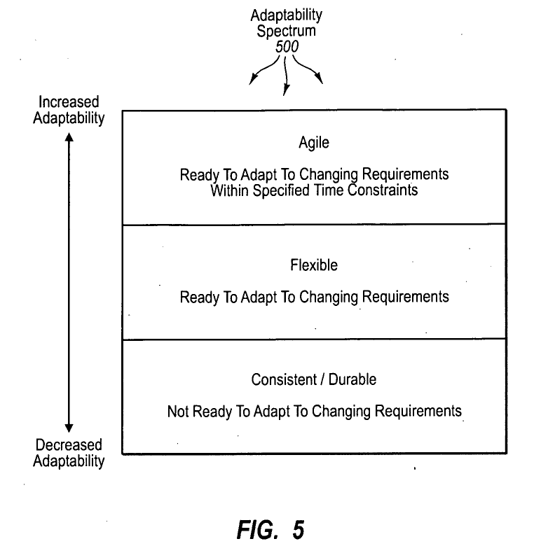

Accordingly, in some embodiments, a pre-defined business change vocabulary can also include a spectrum of adaptability ranging from agile (increased adaptability) to consistent/durable (decreased adaptability). “Flexibility” can be included within the pre-defined business change vocabulary. Flexibility indicates more adaptability than consistent/durable but less adaptability than agile. Referring briefly to FIG. 5, FIG. 5 depicts adaptability spectrum 500. As depicted, adaptability spectrum 500 includes a range of adaptabilities from agile to consistent/durable. Adaptability spectrum 500 can be included along with change spectrum 122 in business change vocabulary 121. In these embodiments, capability changes 123 can also indicate mechanisms for changing the adaptability of business capabilities.

Accordingly, a pre-defined business change vocabulary can also define adaptability changes. Adaptability changes are activities that an organization can implement for business capabilities to alter adaptability of the business capabilities within an adaptability spectrum. Adaptability changes can include how to alter the adaptability of a business capability to make the business capability more or less adaptable. For example, an adaptability change can indicate how transform a flexible business capability into an agile business capability (or vice versa).

Thus, embodiments of the invention can include considering changes to and changing the adaptability of a variety of different types of business capabilities. For example, adaptability changes can be considered and implemented for economic driver/core capabilities, enabling or infrastructure capabilities, and management capabilities. For example, business capability change 114 can represent a change to the adaptability of business capability 191.

Thus, generally, a potential change to an organization's business capabilities be analyzed and a potential change implemented in view of a set of conditions representing a business environment. Embodiments of the invention can be used to analyze and evaluate the impact of a potential business capability change in view of a set of conditions. Based on analysis and evaluation of business capability changes, business capability For example, if a business capability change yields improved results during simulated implementation, the business capability change can be applied for actually implementation within an organization.

Further, a pre-defined business change vocabulary provides a mechanism for any organization to consider business capability changes in a uniform manner. For example, business change vocabulary 121 provides a mechanism for organization 190 or any other organization to consider business capability changes to business capability collection 124 in a uniform manner. Further, a pre-defined business change vocabulary provides a mechanism to produce consistent repeatable results for considered business capability changes to a business capability collection. For example, business change vocabulary 121 provides a mechanism to produce consistent repeatable results for considered business capability changes to business capability collection 124. Thus, for example, a prospective purchaser or investor of organization 190 can more easily verify that (potentially costly) business capability changes would in fact increase performance of organization 190 enough to make the business capability change worthwhile.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed:

1. In a computer architecture, a method for implementing a structured change to some aspect of an organization, the method comprising:
an act of identifying a set of conditions relevant to the ability of one or more of the organization's business capabilities, determining relevancy including:
an act of referring to a pre-defined common vocabulary for business change, the pre-defined common vocabulary defining a range of business change, the pre-defined common vocabulary providing a mechanism for a plurality of different organizations to consider business change in a uniform manner and providing a mechanism to produce consistent repeatable results for considered business changes;
an act of referring to a collection of business capabilities representing the performance of the organization; and
an act of determining that the set of conditions is relevant to the one or more business capabilities, from among the collection of business capabilities, based on the pre-defined common vocabulary for business change;
an act of identifying any significant business capabilities, from among the relevant business capabilities, that expressly and in an asserted fashion impact the performance of the organization in view of the set of conditions;
an act of determining that a change to portion of the significant business capabilities would improve the performance of the organization in a cost efficient manner, based on the pre-defined common vocabulary for business change, the determination including:
an act of identifying the significance of the change to apply to the portion of significant business capabilities; and
an act of identifying the level of coordination within the organization for applying the change to the portion of significant business capabilities; and
an act of applying the change to the portion of the significant business capabilities in response to the determination so as to improve the performance of the organization in view of the set of conditions.

2. The method as recited in claim 1, wherein the act of identifying a set of conditions relevant to the ability of one or more of the organization's business capabilities comprises an act identifying a set of conditions that indicate a business environment for the organization.

3. The method as recited in claim 1, wherein the act of referring to a pre-defined common vocabulary for business change comprises an act of referring to a pre-defined common vocabulary that defines a range of business change within a multi-axis spectrum.

4. The method as recited in claim 1, wherein the act of referring to a pre-defined common vocabulary for business change comprises an act of referring to a pre-defined common vocabulary that defines how to alter business capabilities to cause a change in the functionality of a business capabilities.

5. The method as recited in claim 4, wherein the act of referring to a pre-defined common vocabulary that defines how to alter business capabilities comprises an act of referring to a pre-defined common vocabulary that defines adaptability changes for changing between different adaptabilities in a range of adaptability.

6. The method as recited in claim 1, wherein the act of referring to a collection of business capabilities representing the performance of the organization comprises an act of referring to a collection of business capabilities represented with various different levels of detail.

7. The method as recited in claim 1, wherein the act of referring to a collection of business capabilities representing the performance of the organization comprises an act of referring to a network of interconnected business capabilities.

8. The method as recited in claim 1, wherein the act of identifying any significant business capabilities, from among the relevant business capabilities, that significantly impact performance of the organization in view of the set of conditions comprises an act of identifying one or more business capabilities that satisfy an impact threshold.

9. The method as recited in claim 1, wherein the act of identifying any significant business capabilities, from among the relevant business capabilities, that significantly impact performance of the organization in view of the set of conditions comprises an act of identifying one or more core business capabilities of the organization.

10. The method as recited in claim 1, wherein the act of determining that a change to portion of the significant business capabilities would improve the performance of the organization in a cost efficient manner comprises determining that changing the adaptability of least one of the significant business capabilities would improve the performance of the organization.

11. The method as recited in claim 1, wherein the act of determining that a change to portion of the significant business capabilities would improve the performance of the organization comprises an act associating a cost with the change based on the location of the change in the change spectrum.

12. A computer program product for use in a computer architecture, The computer program product for implementing a method for implementing a structured change to some aspect of an organization, the computer program product comprising one or more computer storage media having stored thereon computer-executable instructions that, when executed at a processor, cause the computer architecture to perform the method including the following:
identify a set of conditions relevant to the ability of one or more of the organization's business capabilities, determining relevancy including:
referring to a pre-defined common vocabulary for business change, the pre-defined common vocabulary defining a range of business change, the pre-defined common vocabulary providing a mechanism for a plurality of different organizations to consider business change in a uniform manner and providing a mechanism to produce consistent repeatable results for considered business changes;
referring to a collection of business capabilities representing the performance of the organization; and
determining that the set of conditions is relevant to the one or more business capabilities, from among the collection of business capabilities, based on the pre-defined common vocabulary for business change;
identify any significant business capabilities, from among the relevant business capabilities, that expressly and in an asserted fashion impact the performance of the organization in view of the set of conditions;
determine that a change to portion of the significant business capabilities would improve the performance of the organization in a cost efficient manner, based on the pre-defined common vocabulary for business change, the determination including:
identifying the significance of the change to apply to the portion of significant business capabilities; and
identifying the level of coordination within the organization for applying the change to the portion of significant business capabilities; and
apply the change to the portion of the significant business capabilities in response to the determination so as to improve the performance of the organization in view of the set of conditions.

13. The computer program product as recited in claim 12, wherein computer-executable instructions that, when executed, cause the computer architecture to identify a set of conditions relevant to the ability of one or more of the organization's business capabilities comprise computer-executable instructions that, when executed, cause the computer architecture to identify a set of conditions that indicate a business environment for the organization.

14. The computer program product as recited in claim 12, wherein computer-executable instructions that, when executed, cause the computer architecture to refer to a pre-defined common vocabulary for business change comprises computer-executable instructions that, when executed, cause the computer architecture to refer to a pre-defined common vocabulary that defines a range of business change within a multi-axis spectrum.

15. The computer program product as recited in claim 12, wherein computer-executable instructions that, when executed, cause the computer architecture to refer to a pre-defined common vocabulary for business change comprises computer-executable instructions that, when executed, cause the computer architecture to referring to a pre-defined common vocabulary that defines adaptability changes for changing the adaptability of business capabilities between different adaptabilities in a defined range of adaptability.

16. The computer program product as recited in claim 12, wherein computer-executable instructions that, when executed, cause the computer architecture to refer to a collection of business capabilities representing the performance of the organization comprise computer-executable instructions that, when executed, cause the computer architecture to refer to a collection of business capabilities represented with various different levels of detail.

17. The computer program product as recited in claim 12, wherein computer-executable instructions that, when executed, cause the computer architecture to refer to a collection of business capabilities representing the performance of the organization comprise computer-executable instructions that, when executed, cause the computer architecture to refer to a network of interconnected business capabilities.

18. The computer program product as recited in claim 12, wherein computer-executable instructions that, when executed, cause the computer architecture to identifying any significant business capabilities, from among the relevant business capabilities, that significantly impact performance of the organization in view of the set of conditions comprises computer-executable instructions that, when executed, cause the computer architecture to identify one or more core business capabilities of the organization.

19. The computer program product as recited in claim 12, wherein computer-executable instructions that, when executed, cause the computer architecture to, determine that a change to portion of the significant business capabilities would improve the performance of the organization comprise computer-executable instructions that, when executed, cause the computer architecture to associate a cost with the change based on the location of the change in the change spectrum.

20. A computer system, the computer system comprising:
one or more processors;
system memory;
one or more computer storage media having stored thereon computer-executable instructions of a relevancy module, a significance module, and performance evaluator, wherein the relevancy module is configured to:
identify a set of conditions relevant to the ability of one or more of the organization's business capabilities, determining relevancy including:
referring to a pre-defined common vocabulary for business change, the pre-defined common vocabulary defining a range of business change, the pre-defined common vocabulary providing a mechanism for a plurality of different organizations to consider business change in a uniform manner and providing a mechanism to produce consistent repeatable results for considered business changes;
referring to a collection of business capabilities representing the performance of the organization; and
determining that the set of conditions is relevant to the one or more business capabilities, from among the collection of business capabilities, based on the pre-defined common vocabulary for business change;
wherein the significance module is configured to:
identify any significant business capabilities, from among the relevant business capabilities, that expressly and in an asserted fashion impact the performance of the organization in view of the set of conditions; and
wherein the performance evaluator is configured to:
determine that a change to portion of the significant business capabilities would improve the performance of the organization, based on the pre-defined common vocabulary for business change, the determination including referring to a multi-axis change spectrum to:
identify the significance of the change to apply to the portion of significant business capabilities; and
identify the level of coordination within the organization for applying the change to the portion of significant business capabilities;
assign a cost to the change based on the significance and level of coordination identified from the multi-axis change spectrum;
simulate implementation of the change within the organization to identify any improved performance of the organization resulting from the change;
evaluate the improved performance against the assigned cost to determine if the change is worthwhile;
apply the change to the portion of the significant business capabilities in response to the evaluation so as to improve the performance of the organization in view of the set of conditions.
